(19) United States
(12) Patent Application Publication
(10) Pub. No.: US 2009/0097509 A1
(43) Pub. Date: Apr. 16, 2009

(54) Laser Apparatus

(76) Inventor: Wing Ling Tse, Hong Kong (HK)

Correspondence Address: Ben Kwong, General Commercial Building, Rm404, 4/F., 162 Des Voeux Road, Central, Hong Kong, HK

(21) Appl. No.: 12/179,594

(22) Filed: Jul. 25, 2008

(30) Foreign Application Priority Data
Aug. 7, 2007 (CN) 200720122093.0

(51) Int. Cl. H01S 3/098

(52) U.S. Cl. 372/19

(57) ABSTRACT

This utility model discloses a type of laser apparatus comprising a back mirror, a YV04 crystal, a Q-SW crystal, a front mirror, an optical pumping source, an optical fiber splice, a directional light-regulating lens and a laser head. The back mirror is a plano-concave lens, the incidence point of optical pumping source is deviated from the end surface center of YV04 crystal by 0-2 mm; under the back mirror there is a back mirror regulator; under the Q-SW crystal there is a Q-SW crystal regulator; above the front mirror there is a lens regulator; the laser head is located in front of the back mirror, the directional light-regulating lens is set in front of the laser head, the optical fiber splice is set in front of the directional light-regulating lens and under the lens there is a lens regulator. During use, the optical pumping source may generate two laser resonance paths, thus the laser conversion can be improved, Nd—YV04 is heated uniformly; Because there are two laser resonance paths, so the laser cavity length has a wide range of application: 40 mm-200 mm, in such a way that the technical difficulty in manufacturing the laser cavity is reduced.

### TECHNICAL FIELD

This utility model is related to a laser apparatus, in particular to a type of laser apparatus that the optical pumping source may generate two laser resonance paths.

### BACKGROUND ART

At present, the existing technologies for laser apparatus mainly emphasize that once the 808 nm optical pumping source enters into Nd—YV04 crystal, it will excite as much laser energy as possible, one pumping source has only one path of laser resonance; thus the cavity length of laser resonance has a small range of application, which increases the technical difficulty in manufacturing the laser cavity.

### Contents of the Utility Model

This utility model provides a laser apparatus that an optical pumping source may generate two laser resonance paths, so the laser cavity length has a wide range of application and the technical difficulty in manufacturing the laser cavity is reduced.

To realize the purpose of the utility model described above, the technical solution to be adopted for this utility model is:

A laser apparatus as mainly comprising: back mirror, YV04 crystal, Q-SW crystal, front mirror and optical pumping source, the said back mirror is a plano-concave lens, the incidence point of optical pumping source is deviated from the end surface center of YV04 crystal by 0-2 mm.

The radian of said back mirror R=100 mm^{˜}2000 mm, coated, one side 800^{˜}970 nm light fully transparent, the concave 1050^{˜}1380 nm light fully reflected.

The said YV04 crystal: a-cut, 0.2%-2% Nd Doped, coated: 800^{˜}970 nm 1050^{˜}1380 nm fully transparent on both sides.

The said Q-SW crystal is 1050-1950 nm, light fully transparent.

The said laser apparatus, under the back mirror there is a back mirror regulator.

The said laser apparatus, under the Q-SW crystal there is a Q-SW crystal regulator.

The said laser apparatus, above the front mirror there is a lens regulator.

The said laser apparatus also comprises: an optical fiber splice, a directional light-regulating lens and a laser head, the said laser head is set in front of the back mirror, the directional light-regulating lens is set in front of the laser head, and the optical fiber splice is set in front of the directional light-regulating lens.

Under the said lens there is a lens regulator.

After above structure is adopted, during use, optical pumping source may generate two laser resonance paths, one path is: the incidence from optical pumping source to Nd—YV04 crystal will generate a path of laser; then by way of diffuse reflection 808 nm light generates another path of laser; thus the laser conversion can be improved, Nd—YV04 is heated uniformly. Because there are two laser resonance paths, so the laser cavity length (the resonant cavity length means the distance from the back mirror to front mirror) has a wide range of application: 40 mm-200 mm, in such a way the technical difficulty in manufacturing the laser cavity is reduced.

### DESCRIPTION OF FIGURES

FIG. 1 is the schematic structural diagram of dual-path resonant cavity generated for this utility model;

FIG. 2 is the schematic structural diagram for use of this utility model.

### MODE OF CARRYING OUT THE UTILITY MODEL

To make it possible for those who are skilled in the art to better understand this utility model, with the attached drawings and the embodiment, below is the further descriptions of this invention.

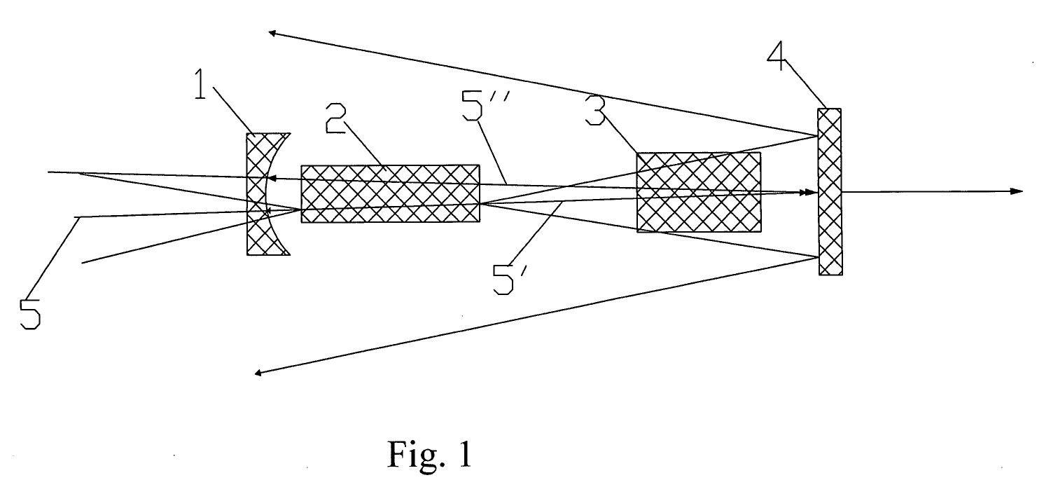

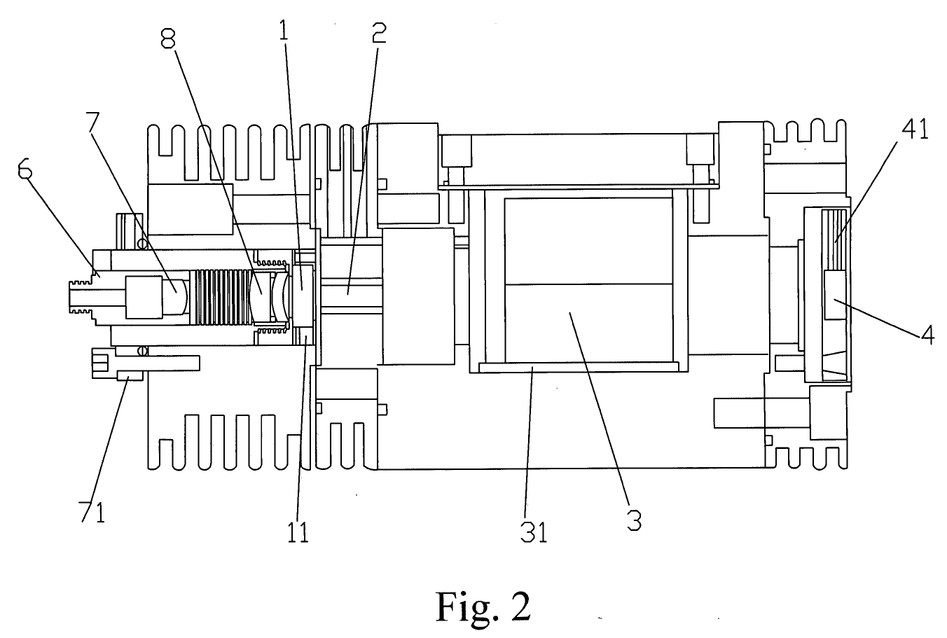

As shown in FIG. 1 and FIG. 2, it discloses a laser apparatus mainly comprising: a back mirror 1, a YV04 crystal 2, a Q-SW crystal 3, a front mirror 4, an optical pumping source 5, an optical fiber splice 6, a directional light-regulating lens 7 and a laser head 8, wherein:

The said back mirror 1 is the plano-concave lens, the incidence point of optical pumping source 5 is deviated from the end surface center of YV04 crystal 2 by 0-2 mm.

The radian of the said back mirror 1 R=100 mm^{˜}2000 mm, coated, one side 800^{˜}970 nm light fully transparent, the concave 1050^{˜}1380 nm light fully reflected.

The said YV04 crystal 2: a-cut, 0.2%-2% Nd Doped, coated: 800^{˜}970 nm 1050^{˜}1380 nm fully transparent on both sides.

The said Q-SW crystal 3 is 1050-1950 nm, light fully transparent.

A laser apparatus as said, under the back mirror 1 there is a back mirror regulator 11, and the back mirror regulator 11 can regulate the light path, which will keep it on the same optical axis with the YV04 crystal 2.

A laser apparatus as said, under the Q-SW crystal 3 there is a Q-SW crystal regulator 31, and the Q-SW crystal regulator 31 can regulate the light path, which will break the laser resonance path.

A laser apparatus as said, under the front mirror 4 there is a lens regulator 41, and the lens regulator 41 can regulate the light path, which will keep it on the same optical axis with the back mirror. In addition to regulating the light path, it can also be used to reflect all the light, which is equal to a reflector with opening and assisting in generate another path of laser.

The said laser head 8 is set in front of the back mirror 1, the directional light-regulating lens 7 is set in front of the laser head 8, and the optical fiber splice 6 is set in front of the directional light-regulating lens 7.

Under lens 7 there is a lens regulator 71, the said lens regulator 71 can regulate the incidence light path, which will make the light to reach the strongest point for output.

During use, optical pumping source may generate two laser resonance paths, one path is: the incidence from optical pumping source to Nd—YV04 crystal will generate a path of laser 5′; then by way of diffuse reflection 808 nm light generates another path of laser 5″; thus the laser conversion can be improved, Nd—YV04 is heated uniformly. Because there are two laser resonance paths, so the laser cavity length (the resonant cavity length means the distance from the back mirror to front mirror) has a wide range of application: 40 mm-200 mm, in such a way the technical difficulty in manufacturing the laser cavity is reduced.

The embodiment has depicted this invention; however, as are well known to those of ordinary skill in the art, this invention has many transformations and variations without being disengaged from the spirit of this invention. It is intended that the attached claims contain these transformations and variations without being disengaged from the spirit of this invention.

1. A laser apparatus characterized in that it mainly comprises: a back mirror, a YV04 crystal, a Q-SW crystal, a front mirror and an optical pumping source, the said back mirror is a plano-concave lens, the incidence point of optical pumping source is deviated from the end surface center of YV04 crystal by 0-2 mm.

2. A laser apparatus as set forth in claim 1 characterized in that the radian of the said back mirror R=100 mm^{˜}2000 mm, coated, one side 800^{˜}970 nm light fully transparent, the concave 1050^{˜}1380 nm fully reflected.

3. A laser apparatus as set forth in claim 1 or 2 characterized in that the said YV04 crystal: a-cut, 0.2%-2% Nd Doped, coated: 800^{˜970} nm 1050^{˜}1380 nm fully transparent on both sides.

4. A laser apparatus as set forth in claim 3 characterized in that the Q-SW crystal is 1050-1950 nm, light fully transparent.

5. A laser apparatus as set forth in claim 4 characterized in that under the back mirror there is a back mirror regulator.

6. A laser apparatus as set forth in claim 5 characterized in that under the Q-SW crystal there is a Q-SW crystal regulator.

7. A laser apparatus as set forth in claim 6 characterized in that above the front mirror there is a lens regulator.

8. A laser apparatus as set forth in claim 7 characterized in that it also comprises: optical fiber splice, directional light-regulating lens and laser head, the said laser head is set in front of the back mirror, the directional light-regulating lens is set in front of the laser head, and the optical fiber splice is set in front of the directional light-regulating lens.

9. A laser apparatus as set forth in claim 8 characterized in that under the said lens there is a lens regulator.
